(19) United States
(12) Patent Application Publication
(10) Pub. No.: US 2016/0046878 A1
(43) Pub. Date: Feb. 18, 2016

(54) ULTRASONIC CAVITATION REACTOR FOR PROCESSING HYDROCARBONS AND METHODS OF USE THEREOF

(71) Applicant: Roger K. Lott, Edmonton (CA)

(72) Inventor: Roger K. Lott, Edmonton (CA)

(21) Appl. No.: 14/823,848

(22) Filed: Aug. 11, 2015

Related U.S. Application Data
(60) Provisional application No. 62/036,418, filed on Aug. 12, 2014.

(51) Int. Cl. C10G 47/24; C10G 1/00; B01J 19/10; C10G 65/12; B01J 19/00; C10G 1/06; C10G 65/10

(52) U.S. Cl. CPC C10G 47/24; C10G 1/06; C10G 1/002; C10G 65/10; C10G 65/12; B01J 19/008; B01J 19/10; B01J 2219/0877; B01J 2219/0879; B01J 2219/0892; B01J 2219/0871

(57) ABSTRACT

Systems and methods for upgrading or improving the quality of a heavy oil feedstock. The systems and methods described herein utilize cavitation energy, such as ultrasonic cavitation energy, to transmit ultrasonic or other cavitation energy (e.g., cavitation forces, shear, microjets, shockwaves, micro-convection, local hotspots, and the like) into heavy oil to drive hydroconversion under low pressure hydrogen condition (e.g., less than 500 psig) that are not conventionally believed to be suitable for treating heavy oil.

### CROSS REFERENCE TO RELATED APPLICATION

This application claims the benefit of U.S. Provisional Application No. 62/036,418, filed Aug. 12, 2014, the disclosure of which is incorporated herein in its entirety.

### BACKGROUND

It is generally desired in the petroleum industry to “upgrade” lower quality feedstocks (e.g., heavy hydrocarbon oil) into lower boiling hydrocarbons that have higher economic value. In addition, the petroleum industry continues to desire a process that can convert heavy whole petroleum crude oil to a lighter crude oil having a substantially reduced amount of heavy hydrocarbon oil content, particularly asphaltenes. Other advantages sought through the treatment of heavy hydrocarbon oil, heavy whole petroleum crude oil and other similar feeds, particularly high boiling petroleum refinery residues, include hydrodesulfurization (HDS), hydrodenitrogenation (HDN), carbon residue reduction (CRR), hydrodemetallization (HDM), and sediment reduction.

Lower quality feedstocks are characterized as including relatively high quantities of hydrocarbons that have a boiling point of 524° C. (975° F.) or higher. They also contain relatively high concentrations of sulfur, nitrogen and metals. High boiling fractions typically have a high molecular weight and/or low hydrogen/carbon ratio, an example of which is a class of complex compounds collectively referred to as “asphaltenes”. Asphaltenes are difficult to process and commonly cause fouling of conventional catalysts and hydroprocessing equipment.

Examples of lower quality feedstocks that contain relatively high concentrations of asphaltenes, sulfur, nitrogen and metals include heavy crude and oil sands bitumen, as well as bottom of the barrel and residuum left over from conventional refinery process (collectively “heavy oil”). The terms “bottom of the barrel” and “residuum” (or “resid”) typically refer to atmospheric tower bottoms, which have a boiling point >343° C. (650° F.), or vacuum tower bottoms, which have a boiling point >524° C. (975° F.). The terms “resid pitch” and “vacuum residue” are commonly used to refer to fractions that have a boiling point >524° C. (975° F.).

Hydroconversion, an example of which is hydrocracking, achieve the goal of “upgrading” lower quality feedstocks by reacting the feedstock with hydrogen gas in the presence of a transition metal catalyst—such as a heterogeneous supported catalysts, micron and nano sized catalysts, homogeneous catalysts, or a combination thereof. Heterogeneous transition metal catalysts are typically supported on high surface area refractory oxides such as alumina, silica, alumino-silicates, and others known to one skilled in the art. Such catalyst supports have complex surface pore structures, which may include pores that are relatively small in diameter (i.e., micropores) and pores that are relatively large in diameter (i.e., macropores) that affect the reaction characteristics of the catalyst. A considerable amount of research has been done with regards to changing the properties of hydroconversion catalysts by modifying the pore sizes, pore size distribution, pore size ratios and other aspects of the catalyst surface and has resulted in the achievement of many of the aforementioned goals of hydroconversion.

An excellent example of such achievements is disclosed in U.S. Pat. No. 5,435,908 by Nelson et al., in which a supported catalyst achieves good levels of hydroconversion of heavy hydrocarbon feeds to products having an atmospheric boiling point less than 538° C. (1000° F.). Simultaneously, the catalyst and process disclosed produces a liquid having an atmospheric boiling point greater than 343° C. (650° F.), with low sediment content and a product having an atmospheric boiling point greater than 538° C. (1000° F.) having a low sulfur content. The catalyst includes a Group VIII non-noble metal oxide and a Group VI-B metal oxide supported on alumina. The alumina support is characterized as having a total surface area of 150-240 m²/g, a total pore volume (TPV) of 0.7 to 0.98, and a pore diameter distribution in which ≦20% of the TPV is present as primary micropores having diameters less than or equal to 100 Å. At least about 34% of the TPV is present as secondary micropores having diameters from about 100 Å to about 200 Å, and about 26% to about 46% of the TPV is present as macropores having diameters greater than about 200 Å.

Another method to substantially achieve some of the above noted goals of the hydroconversion of heavy oil feeds is disclosed in U.S. Pat. No. 5,108,581 by Aldrich et al. As is disclosed in the '581 patent, a dispersible or decomposable catalyst precursor (i.e., homogeneous catalyst precursor) along with hydrogen gas, preferably containing hydrogen sulfide, is added to a heavy oil feed and the mixture heated under pressure to form a catalyst concentrate. This catalyst concentrate is then added to the bulk of the heavy oil feed, which is introduced into a hydroconversion reactor. Suitable conditions for the formation of the catalyst concentration include temperatures of at least 260° C. (500° F.) and elevated pressure from 170 kPa (10 psig) to 13,890 kPa (2000 psig) with exemplary conditions being 380° C. (716° F.) and 9,754 kPa (1400 psig). As is taught by the disclosure, the goal of such conditions is to decompose the catalyst precursor so as to form catalyst particles dispersed in the hydrocarbon oil of the catalyst concentrate before it is mixed with the bulk of the heavy feed oil in the hydroconversion reactor.

However, despite such advances, the hydroconversion process of heavy hydrocarbon oil requires elevated reactor temperatures (e.g., greater than 315° C. (600° F.)) and high pressures (e.g., above 13,890 kPa (2000 psig)) of hydrogen containing gas. Due to the combination of elevated temperature and high pressures of hydrogen gas, the costs of building and operating a hydroconversion reactor are considerable due to the high consumption of hydrogen, the reactor has to very robust in order to tolerate the operating pressures, and, due to the high operating pressures, there are considerable safety issues associated with operating a hydroconversion reactor.

One way to reduce these costs and to improve safety of the reactor is to lower the reactor pressure. However, one impediment to lowering the pressure is that it is well known in the art that operating a hydroconversion reaction at pressures below 13,890 kPa (2000 psig) causes the formation of intractable residues in the reactor and high levels of sediment in the product stream. The collection of residues and other sediments in the reactor and other process systems creates reactor conditions that are unpredictable and unstable. If this is to be avoided, frequent reactor shutdown and cleaning is required, which causes loss of production because the reactor is not “on-line.” Clearly unstable and unpredictable reaction conditions are not desirable from a product quality point of view, from a reactor operations point of view or more importantly from a safety point of view.

### SUMMARY

Described herein are systems and methods for upgrading or improving the quality of a heavy oil feedstock. Heavy oil feedstocks generally have low economic value, whereas upgraded heavy oil contains a larger percentage of higher value, lower boiling components. The systems and methods described herein utilize cavitation (e.g., ultrasonic cavitation, or “ultrasonication”) to transmit ultrasonic cavitation energy (e.g., cavitation forces, shear, microjets, shockwaves, micro-convection, local hotspots, and the like) into the heavy oil and to drive hydroconversion under conditions that are not conventionally believed to be suitable for treating heavy oil. For instance, the systems and methods described herein utilize hydrogen in a hydrocracking reaction at much lower pressures than conventionally believed to be possible (e.g., less than 500 psig). This improves the safety and lowers the cost of heavy oil upgrading.

In an embodiment, a heavy oil upgrading system is described. The heavy oil upgrading system includes an ultrasonic cavitation reactor, which includes a heavy oil feedstock, and a pressure vessel containing a heater configured for heating the heavy oil feedstock in the pressure vessel to a temperature sufficient for hydrocracking, hydrogen gas at less than 500 psig dispersed in the heavy oil feedstock, and a catalyst configured for upgrading the heavy oil feedstock. The ultrasonic cavitation reactor further includes an ultrasonicator positioned and configured to transmit ultrasonic energy in contact with the heavy oil feedstock, the hydrogen gas, and the catalyst. The ultrasonic cavitation reactor may be fluidly coupled to one or more downstream separators for recovering upgraded products from the heavy oil feedstock and/or downstream reactors for further reaction (i.e., further upgrading) the heavy oil from the ultrasonic cavitation reactor.

In one embodiment, the ultrasonicator may include an ultrasonic transmitter positioned in the pressure vessel in contact with the heavy oil feedstock. While ultrasonication can effect mixing, it may be desirable to include a mixer in the pressure vessel for mixing the heavy oil feedstock in contact with the ultrasonic transmitter. In another embodiment, the ultrasonicator may include a circulating channel fluidly coupled to the pressure vessel, an ultrasonic transmitter positioned in a flow cell positioned along the circulating channel, and a pump fluidly coupled to the circulating channel configured to pump the heavy oil feedstock from the pressure vessel, through the circulating channel and the flow cell, and back into the pressure vessel.

In another embodiment, a method for upgrading a heavy oil feedstock is disclosed. The method includes (1) providing a heavy oil feedstock, hydrogen gas, and a catalyst configured for upgrading the heavy oil feedstock, (2) providing an ultrasonic cavitation reactor that includes a pressure vessel, a heater configured for the heavy oil feedstock in the pressure vessel to a temperature sufficient for hydrocracking, and an ultrasonicator positioned so as to contact the heavy oil feedstock, and (3) combining the hydrogen gas, the heavy oil feedstock, and the catalyst in the ultrasonic cavitation reactor under hydrocracking conditions to convert at least a portion of the heavy oil feedstock to lower boiling hydrocarbons, wherein the hydrogen gas is at less than 500 psig. The method further includes (4) transmitting ultrasonic cavitation energy into the heavy oil feedstock in contact with the heavy oil feedstock, the hydrogen gas, and the catalyst so as to form volatile upgraded products and non-volatile upgraded products from the heavy oil feedstock, and (5) recovering the volatile and non-volatile upgraded products from an upgraded heavy oil feedstock.

In yet another embodiment, a method for upgrading a heavy oil feedstock is disclosed. The method includes (1) providing a heavy oil feedstock, hydrogen gas, and a catalyst configured for upgrading the heavy oil feedstock, wherein the catalyst is at least one of a fixed bed catalyst, a stirred bed catalyst, an ebullated bed catalyst, or a slurry phase catalyst, (2) providing a first ultrasonic cavitation reactor that includes a pressure vessel, a heater configured for the heavy oil feedstock in the pressure vessel to a temperature sufficient for hydrocracking, and an ultrasonicator positioned in contact with the heavy oil feedstock, (3) combining the hydrogen gas, the heavy oil feedstock, and the catalyst in the ultrasonic cavitation reactor under hydrocracking conditions to convert at least a portion of the heavy oil feedstock to lower boiling hydrocarbons, wherein the hydrogen gas is at less than 500 psig, and (4) transmitting ultrasonic cavitation energy into the heavy oil feedstock in contact with the heavy oil feedstock, the hydrogen gas, and the catalyst so as to form an upgraded heavy oil feedstock that includes volatile upgraded products and non-volatile upgraded products.

The method further includes a step (5) of transferring the upgraded heavy oil feedstock from the first ultrasonic cavitation reactor to a flash separator, the flash separator being configured for separating unreacted hydrogen and the volatile upgraded products from the upgraded heavy oil feedstock, and a step (6) of transferring the upgraded heavy oil feedstock from the flash separator to a first backmixed bubbling reactor. The method further includes a step (7) of transferring the upgraded heavy oil feedstock from the first backmixed bubbling reactor to an interstage separator configured for separating unreacted hydrogen and volatile hydrocarbons from the upgraded heavy oil feedstock from the first backmixed bubbling reactor, a step (8) of transferring the upgraded heavy oil feedstock from the interstage separator to a second backmixed bubbling reactor, and a step (9) of recovering non-volatile upgraded products from the upgraded heavy oil feedstock from one or more of the first ultrasonic reactor, the flash separator, the first backmixed bubbling reactor, the interstage separator, or the second backmixed bubbling reactor.

One will appreciate that the order of one or more of the first ultrasonic cavitation reactor, the flash separator, the first backmixed bubbling reactor, the interstage separator, or the second backmixed bubbling reactor recited in the apparatuses and methods disclosed herein may be changed without departing from the spirit of the present invention. Likewise, one will appreciate that any one of the first ultrasonic cavitation reactor, the flash separator, the first backmixed bubbling reactor, the interstage separator, or the second backmixed bubbling reactor recited in the apparatuses and methods described herein may be duplicated without departing from the spirit of the present invention.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a process flow scheme for upgrading of hydrocarbons using an ultrasound cavitation reactor;

FIG. 2 illustrates an ultrasonicator for use in an ultrasound cavitation reactor for upgrading of hydrocarbons, according to one embodiment of the present invention;

FIG. 3 illustrates another ultrasonicator for use in an ultrasound cavitation reactor for upgrading of hydrocarbons, according to one embodiment of the present invention;

FIG. 4 illustrates a process flow scheme for upgrading of hydrocarbons with an upgraded product from an ultrasound cavitation reactor being further upgraded in at least one backmixed bubbling reactor;

FIG. 5 illustrates a process flow scheme for upgrading of hydrocarbons that includes two or more ultrasound cavitation reactors connected in series;

FIG. 6 illustrates a process flow scheme for upgrading of hydrocarbons that includes a pump that may be used to admix at least one of a catalyst or hydrogen gas into a heavy oil feedstock prior to entering an ultrasound cavitation reactor; and

FIG. 7 illustrates a process flow scheme for upgrading of hydrocarbons with combination of a pump to disperse hydrogen and/or catalyst in hydrocarbons prior to entering an ultrasound cavitation reactor and downstream processing of partially upgraded hydrocarbon with fresh hydrogen in at least two backmixed bubbling reactors in combination with an interstage separator, and recycling of unconverted hydrocarbons.

### DETAILED DESCRIPTION

### I. Introduction and Definitions

Described herein are systems and methods for upgrading or improving the quality of a heavy oil feedstock. Heavy oil feedstocks generally have low economic value, whereas upgraded heavy oil contains a larger percentage of higher valued, lower boiling components. The systems and methods described herein utilize ultrasonic cavitation to transmit ultrasonic cavitation energy (e.g., cavitation forces, shear, microjets, shockwaves, micro-convection, local hotspots, and the like) into heavy oil to drive hydroconversion under conditions that are not conventionally believed to be suitable for treating heavy oil. For instance, the systems and methods described herein utilize hydrogen in a hydrocracking reaction at much lower pressures than conventionally believed to be possible (e.g., less than 500 psig).

The conventional approach to heavy oil upgrading has been to rely on very high hydrogen gas pressures (e.g., in excess of 2000 psig) and high temperatures in the presence of a catalyst. However, such systems can be uneconomical due to the need of high hydrogen circulation rate, high cost of recovering excess hydrogen, high equipment manufacturing costs, and high costs of equipment upkeep. In addition, such systems may be associated with significant safety issues due to the high gas pressures needed to accomplish the hydroconversion reactions. In contrast, the ultrasonic cavitation reactor systems disclosed herein are able to accomplish hydroconversion at much lower hydrogen gas pressure as compared to conventional reactors. This is due to the beneficial effects of ultrasonic cavitation, shear, and other forces within the oil/gas/catalyst mixture. The importance of these effects has not previously been appreciated.

In one embodiment, an ultrasonic cavitation reactor is employed for the upgrading of a heavy oil feed stock. An exemplary ultrasonic cavitation reactor system includes a pressure vessel and an ultrasonicator. The heavy oil feed stock is fed into the pressure vessel of ultrasonic cavitation reactor in the presence of a catalyst and hydrogen gas at less than 500 psig. The ultrasonicator is positioned and configured to transmit ultrasonic energy in contact with the heavy oil feedstock, the hydrogen gas, and the catalyst.

As used herein, the terms “ultrasonic energy” or “ultrasound” refer to mechanical acoustic waves with the frequency range from roughly 10 kHz to 20 MHz. Ultrasonic energy imparts high energy to a reaction medium by cavitation and secondary effects. In a typical dynamic process of cavitation bubbles, numerous microbubbles containing solvent vapors are generated that grow and undergo radial motion as acoustic energy propagates through the liquid medium. These microbubbles grow to a maximum of about 4-300 pm in diameter, and can be stable or transient. With low acoustic intensity, the radii of microbubbles periodically and repetitively expand and shrink (radial oscillation) within several acoustic cycles. While acoustic energy has sufficient intensity, some microbubbles are unstable within only one or two acoustic cycles. When the resonant frequency of bubbles exceeds that of ultrasonic field, the bubbles collapse within several nanoseconds, which creates special physical and chemical effects, and enhances thermochemical reactions or treatment.

The unsymmetrical collapse of bubbles at a broad solid/solvent interface (>200 gm) produces microjets at high speed (>100 m/s) toward solid surfaces. The instantaneous collapse of bubbles also produces strong shockwaves that might be up to 10³ MPa. This violent movement of fluid toward or away from the cavitation bubbles is defined as micro-convection, which intensifies the transport of fluids and solid particles and results in forces that can cause emulsification or dispersion depending on the conditions, while the strong shockwaves and microjets generate extremely strong shear forces over those of conventional mechanical methods, and are able to scatter liquid into tiny droplets or crush solid particles into fine powders.

The chemical effect of ultrasound comes from local hotspots and extremely high localized pressures produced by cavitation. At the moment of bubble collapse, a huge amount of energy is released that cannot be immediately transferred to the surroundings. As a result, local hotspots are developed that have extremely high temperatures (e.g., about 5000° C.), high pressures (e.g., about 50 MPa (7300 psi)) and high rates of heating and cooling in the bubbles (>10⁹° C./s). The extremely high temperature and pressure can destroy the crystalline state of solid materials, cause solids to melt or fuse solid particles when they collide with each other. Ultrasonic energy can cause the formation of short-lifetime reactive radicals such as hydrogen and hydroxyl radicals from reactants or solvent molecules at the moment of bubble collapse.

As used herein, “heavy oil” refers to heavy and ultra-heavy crudes, including but not limited to resids, coals, bitumen, tar sands, etc. Heavy oil feedstock may be liquid, semi-solid, and/or solid. Examples of heavy oil feedstock that might be upgraded as described herein include but are not limited to Canada Tar sands, vacuum resid from Brazilian Santos and Campos basins, Egyptian Gulf of Suez, Chad, Venezuelan Zulia, Malaysia, and Indonesia Sumatra. Other examples of heavy oil feedstock include bottom of the barrel and residuum left over from refinery processes, including “bottom of the barrel” and “residuum” (or “resid”)—atmospheric tower bottoms, which have a boiling point of at least 343° C. (650° F.), or vacuum tower bottoms, which have a boiling point of at least 524° C. (975° F.), or “resid pitch” and “vacuum residue”—which have a boiling point of 524° C. (975° F.) or greater. Properties of heavy oil feedstock may include, but are not limited to: TAN of at least 0.1, at least 0.3, or at least 1; viscosity of at least 1000 cSt; API gravity at most 20 in one embodiment, and at most 10 in another embodiment, and less than 5 in another embodiment. A gram of heavy oil feedstock typically contains at least 0.0001 grams of Ni/V/Fe; at least 0.005 grams of heteroatoms; at least 0.01 grams of residue; at least 0.04 grams C5 asphaltenes; at least 0.002 grams of MCR; per gram of crude; at least 0.00001 grams of alkali metal salts of one or more organic acids; and at least 0.005 grams of sulfur. In one embodiment, the heavy oil feedstock has a sulfur content of at least 5 wt. % and an API gravity of from −5 to +5. A heavy oil feed comprises Athabasca bitumen (Canada) typically has at least 50% by volume vacuum reside. A Boscan (Venezuela) heavy oil feed may contain at least 64% by volume vacuum residue.

In one embodiment, the heavy oil feedstock suitable for use in hydroconversion processes of this reactor is selected from the group consisting of steam assisted gravity drainage (SAGD) produced Alberta bitumen, middle heavy sour crude, atmospheric residuum, vacuum residuum, tar from a solvent deasphalting unit, atmospheric gas oils, vacuum gas oils, deasphalted oils, olefins, oils derived from tar sands or bitumen, oils derived from coal, heavy crude oils, and oils derived from recycled rubber tires, wastes and polymers. In the reactor, at least a portion of the heavy oil feedstock (higher boiling point hydrocarbons) is converted to lower boiling hydrocarbons, forming an upgraded product.

As used herein, the terms “treatment,” “treated,” “upgrade”, “upgrading” and “upgraded”, when used in conjunction with a heavy oil feedstock, describes a heavy oil feedstock that is or has been subjected to hydroprocessing, or a resulting material or crude product, having a reduction in the molecular weight of the heavy oil feedstock, a reduction in the boiling point range of the feedstock, a reduction in the concentration of asphaltenes, a reduction in the concentration of hydrocarbon free radicals, and/or a reduction in the quantity of impurities, such as sulfur, nitrogen, oxygen, halides, and metals.

The upgrading or treatment of heavy oil feeds can be generally referred herein as “hydroprocessing.” Hydroprocessing is meant any process that is carried out in the presence of hydrogen, including, but not limited to, hydroconversion, hydrocracking, hydrogenation, hydrotreating, hydrodesulfurization, hydrodenitrogenation, hydrodemetallation, hydrodearomatization, hydroisomerization, hydrodewaxing and hydrocracking including selective hydrocracking. The products of hydroprocessing may show lower viscosities, better viscosity indices, higher saturates content, lower aromatic content, low temperature properties, volatilities and depolarization, etc.

Heavy oil upgrading is utilized to convert heavy oils or bitumens into commercially valuable lighter products, e.g., lower boiling hydrocarbons, in one embodiment include liquefied petroleum gas (LPG), gasoline, jet, diesel, vacuum gas oil (VGO), and fuel oils.

In the heavy oil upgrading process, a heavy oil feed is treated or upgraded by contact with a catalyst feed in the presence of hydrogen and converted to lighter products. The catalyst may be supported catalyst, fine particles of spent supported catalyst, and/or individual molecule of metal sulfides generated from oil soluble organometallic complexes.

In one embodiment of a heavy oil upgrading process, the process is carried out in the presence of typical solid heterogeneous catalyst commonly used in commercial ebullated bed hydrocrackers.

The solid heterogeneous catalyst employed in the method of this invention may be characterized by a Total Pore Volume of about 0.2 to about 1.2 cc/g, say about 0.77 cc/g; a surface area of about 50 to about 500 m²/g, say about 280 m²/g.

In another embodiment of a heavy oil upgrade process, the process employs a slurry catalyst. On one embodiment, a slurry catalyst may include ground particles of one or more of the heterogeneous catalysts described above. In another embodiment, the slurry catalyst may include catalyst generated from oil-miscible organometallic complex that has mixed into the hydrocarbon feedstock.

Typical oil-miscible or oil-soluble catalyst compounds include, among others, one or mixtures of the following: metal salts of aliphatic carboxylic acids, for example molybdenum stearate, molybdenum palmitate, molybdenum myristate, molybdenum octoate; metal salts of naphthenic carboxylic acids, for example cobalt naphthenate, iron naphthenate, molybdenum naphthenate; metal salts of alicyclic carboxylic acids, for example molybdenum cyclohexane carboxylate; metal salts of aromatic carboxylic acids, for example cobalt benzoate, cobalt o-methyl benzoate, cobalt m-methyl benzoate, cobalt phthallate, molybdenum p-methyl benzoate; metal salts of sulfonic acids, for example molybdenum benzene sulfonate, cobalt p-toluene sulfonate iron xylene sulfonate; metal salts of sulfinic acids, molybdenum benzene sulfinate iron benzene sulfinate; metal salts of phosphoric acids, for example molybdenum phenyl phosphate; metal salts of mercaptans, for example iron octyl mercaptide, cobalt hexyl mercaptide; metal salts of phenols, for example cobalt phenolate, iron phenolate; metal salts of polyhydroxy aromatic compounds, for example iron catecholate, molybdenum resorcinate; organometallic compounds, for example molybdenum hexacarbonyl, iron hexacarbonyl, cyclopentadienyl molybdenum tricarbonyl; metal chelates, for example ethylene diamine tetra carboxylic acid-di-ferous salt; and metal salts of organic amines, for example cobalt salt of pyrrole. Preferred examples of the above compounds include: cobalt naphthenate, molybdenum hexacarbonyl, molybdenum naphthenate, molybdenum octoate, and molybdenum hexanoate.

It has been found that the impact of the oil-miscible catalyst compound may be augmented by use of oil-miscible catalyst compounds of more than one metal. For example if molybdenum (e.g. as the naphthenate) is employed, it is found desirable to add an additional quantity of cobalt (e.g. as the naphthenate). This yields a positive synergistic promotional effect on catalytic desulfurization and demetallization. Typically cobalt may be added in amount of about 0.2 to about 2 moles, say 0.4 moles per mole of molybdenum.

The oil-miscible catalyst compound should be present in amount less than about 600 wppm (i.e., of metal) say about 1 to about 200 wppm based on hydrocarbon oil to be hydroconverted. In one embodiment the amount of oil-miscible catalyst compound should be present in an amount of about 15 to about 100 wppm based on the charge hydrocarbon oil.

In one embodiment, the slurry catalyst includes particles (or particulates) having an average particle size of at least 1 micron. In another embodiment, the catalyst slurry comprises catalyst particles having an average particle size in the range of 1-20 microns. In a third embodiment, the catalyst particulates have an average particle size in the range of 2-10 microns. In one embodiment, the slurry catalyst comprises a catalyst having an average particle size ranging from colloidal (nanometer size) to about 1-2 microns. In another embodiment, the slurry catalyst comprises a catalyst having molecules and/or extremely small particles that are colloidal in size (i.e., less than 100 nm, less than about 10 nm, less than about 5 nm, and less than about 1 nm), forming aggregates having an average size ranging from 1 to 10 microns in one embodiment, and 1 to 20 microns in another embodiment, and less than 10 microns in yet a third embodiment.

In one embodiment, the reactor condition is controlled to be more or less uniform across the ultrasonic reactor. In one embodiment, the reactor is maintained under hydrocracking conditions, i.e., at a minimum temperature to effect hydrocracking of a heavy oil feedstock, e.g., a bulk temperature of 100° C. to 460° C., and a pressure from 1 to 500 psig. However, one will appreciate that because of the action of the ultrasonic generator, localized temperatures and pressures, such as but not limited to at sites of cavitation, may be much higher. Ultrasound can significantly lower reaction temperature and pressure under the conditions described herein, such that the ultrasound reactor(s) can be operated at much lower bulk temperature and pressure than is conventional while maintaining hydrotreating or hydrocracking conditions. In one embodiment, the bulk reactor temperature may range from about 100° C. to about 400° C., from about 200° C. to about 450° C., less than about 440° C., less than about 400° C., or in another embodiment, more than about 300° C. but less than about 410° C.

In one embodiment, the reactor pressure (e.g., the hydrogen pressure or the hydrogen partial pressure) in an ultrasound cavitation reactor may be less than about 500 psig, less than about 450 psig, less than about 400 psig, less than about 350 psig, less than about 300 psig, less than about 250 psig, less than about 200 psig, less than about 150 psig, less than about 100 psig, or less than about 50 psig. In one embodiment, the reactor pressure (e.g., the hydrogen pressure or the hydrogen partial pressure) may in a range from about 5 psig to about 500 psig, about 50 psig to about 450 psig, 100 psig to about 400 psig, 200 psig to about 350, about 250 psig to about 300 psig, or any combination of the foregoing.

In the prior art for slurry catalyst use, the particles are so small (such as 1-10 micron) that recirculation with a pump is not usually necessary to create sufficient motion of the catalyst to obtain a mixed flow effect. Therefore, recirculation pumps are typically used with processes employing extrudate catalyst pellets (typically 1 mm in diameter by 2 mm in length). However, recirculation, even in homogeneous catalyst system, serves to rapidly reduce localized hot spots or uneven temperature distribution in the reactor fluid to prevent run away reactions.

In one embodiment, the reactor system is characterized as having a recirculation system that would allow a recirculation of a liquid (slurry) flow in the reactor. In one embodiment, the pump system recirculates a slurry flow from near the top (outlet) of the reactor back to the bottom (inlet). In another embodiment, the recirculation system comprises appropriate piping, tubing, etc. for conveying liquid from the outlet to the inlet. In one embodiment, instead of or in addition to a pumping apparatus, an upward flow device is employed.

In one embodiment in addition to the recirculation system, the reactor further comprises a mixer in the form of a stirrer, internal baffles, an agitator, or the like, for mixing liquid with substances added thereto (e.g. the substrate, the reagent, solvent, carrier liquid etc.). In another embodiment, the mixer may be disposed within the recirculation system itself, for example in the piping or tubing thereof.

Additional discussion of various heavy oil treating systems, including discussion of various types of reactors vessels and catalyst systems, which may be used with the ultrasonic reactor systems described herein may be found in one or more of U.S. Pat. Nos. 4,134,825, 4,066,530, 5,372,705, 5,868,923, 5,622,616, 6,136,179, and 8,236,170, the disclosures of which are incorporated herein by reference.

### II. Cavitation Reactor Systems

Reference will now be made to the figures to further illustrate embodiments of the invention.

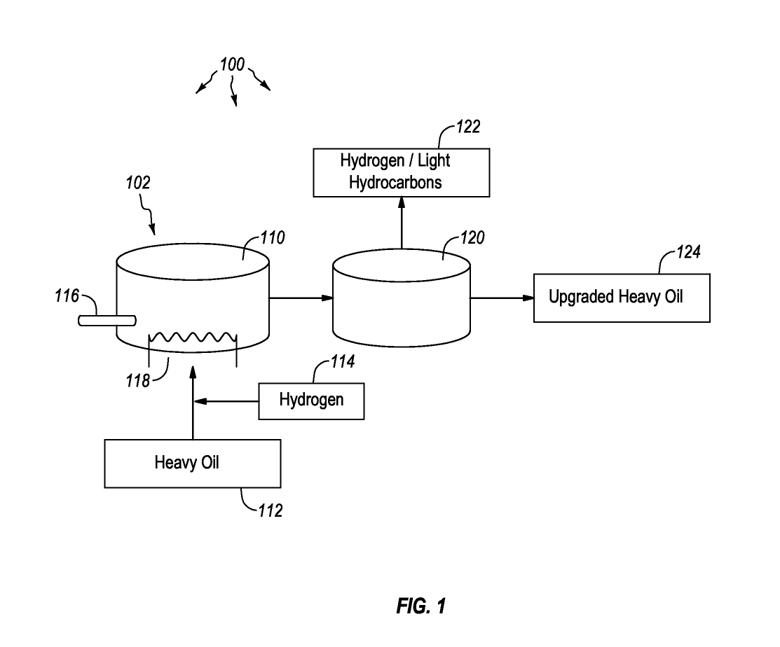

FIG. 1 illustrates a process flow scheme for a heavy oil upgrading system 100 for upgrading of hydrocarbons using a cavitation reactor 102. According to some embodiments, cavitation reactor 102 is an ultrasonic cavitation reactor and includes a pressure vessel 110 and an ultrasonicator 116 positioned and configured to transmit ultrasonic energy in contact with a heavy oil feedstock, a hydrogen gas, and a catalyst. In one embodiment, the catalyst may be generated by the ultrasound energy (e.g., cavitation) from one or more oil-soluble precursors mixed into the heavy oil feedstock.

In general, cavitation reactor 102 can be any reactor able to create cavitation within the reactor. According to some embodiments, cavitation reactor 102 is an ultrasonic cavitation reactor that generates ultrasound acoustic cavitation. In other embodiments, cavitation reactor 102 may include a spinning rotor capable of creating mechanical cavitation. In yet other embodiments, cavitation reactor 102 can include structures that generate cavitation by means of an oscillating magnetic field. Cavitation energy can alternatively be created by hydrodynamic flow of liquid reactants. In other embodiments, cavitation reactor 102 can employ optic cavitation (e.g., by laser pulses) or particle cavitation (e.g., by proton or neutrino pulses).

In one embodiment, a heavy oil feedstock 112 (e.g., heavy oil, resid, coal and heavy oil, and the like) is fed into pressure vessel 110 with a relatively low pressure hydrogen gas 114 (e.g., at less than 500 psig) dispersed in the heavy oil 112. In one embodiment, pressure vessel 110 may be configured as a fixed bed reactor, a stirred bed reactor, an ebullated bed reactor, or a slurry phase reactor. In some embodiments, a slurry catalyst or oil soluble catalyst (e.g., powder of spent ebullated bed hydrocracking catalyst, or catalyst precursor such as molybdenum naphthanate, 2-ethyl molybdenum hexanoate, other oil soluble form of naphthanate e.g., nickel, vanadium, or iron) may be mixed with heavy oil feedstock 112 prior to feeding the heavy oil into pressure vessel 110. In such an embodiment, pressure vessel 110 may be equipped with a catalyst system (e.g., a fixed bed or ebullated bed catalyst) prior to feeding heavy oil 112 into pressure vessel 110 or the slurry or oil soluble catalyst may be the sole catalyst.

In some embodiments, pressure vessel 110 includes a heater 118 configured for heating a heavy oil feedstock in pressure vessel 102 to a temperature sufficient for hydrocracking. Alternatively, the heavy oil feedstock may be heated to a selected temperature (e.g., about 350° C.) prior to feeding the heavy oil into pressure vessel 110.

In the embodiment illustrated in FIG. 1, the product of the ultrasound cavitation reactor 102 may be fed for a flash separator 120 following treatment of the feedstock in the ultrasound cavitation reactor 102. Flash separators, which are also typically referred to as vapor-liquid separators, are devices used in oil refining and treatment and other industrial applications to separate a vapor-liquid mixture. In the present case, flash separator 120 is used to separate a gaseous fraction 122 that includes unreacted hydrogen gas and volatile hydrocarbons (methane, ethane, etc.) from a liquid fraction 124 that includes upgraded hydrocarbons.

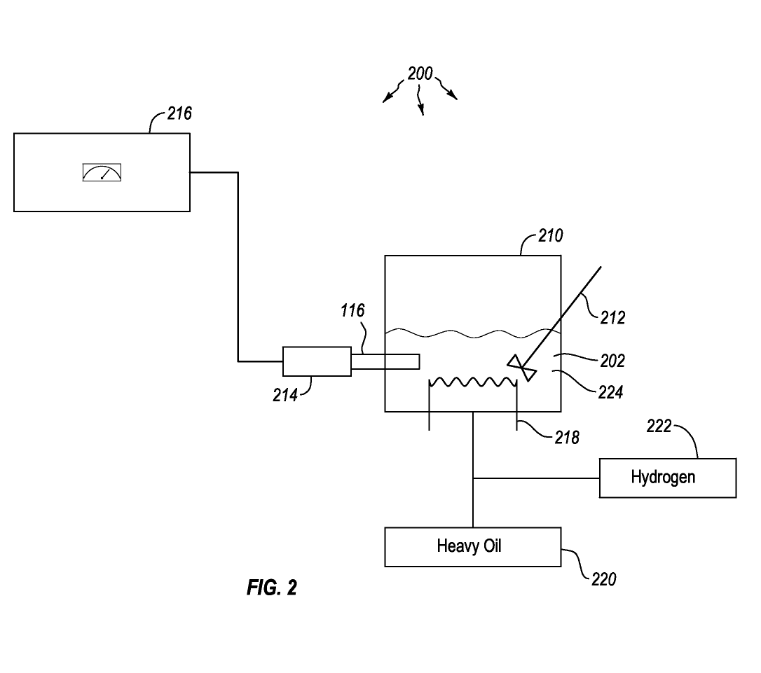

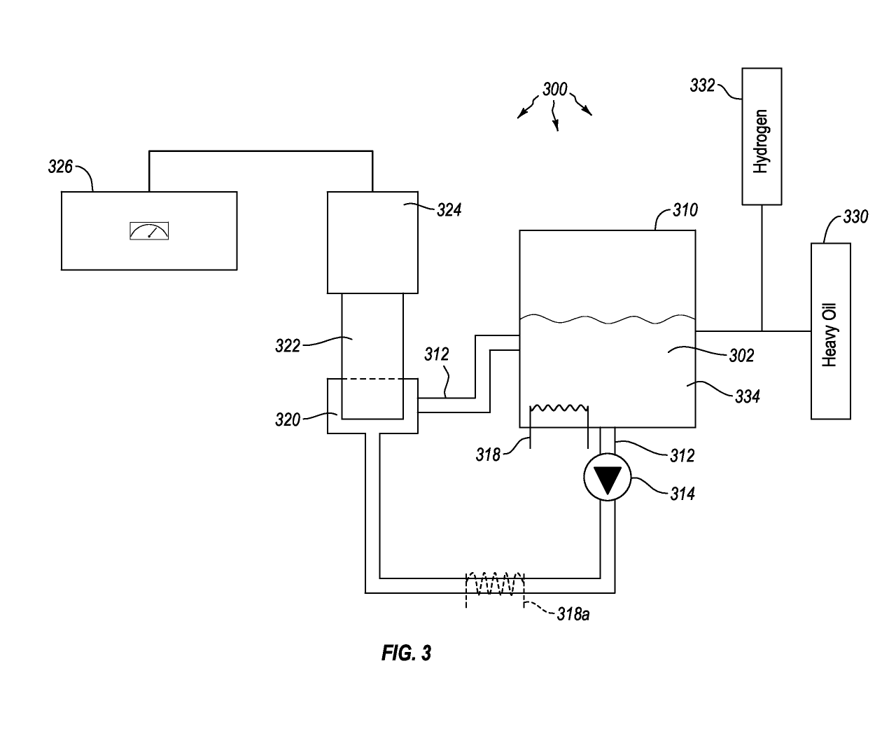

Referring now to FIGS. 2 and 3, embodiments of an ultrasound cavitation reactor system are illustrated in greater detail. In the embodiment illustrated in FIG. 2, the ultrasonicator is positioned in the pressure vessel. In contrast, in the embodiment illustrated in FIG. 3, the ultrasonicator is positioned in a flow cell outside the pressure vessel.

Referring now specifically to FIG. 2, an illustrated ultrasound cavitation reactor 200 includes a pressure vessel 210, a mixer apparatus 212 that is configured to mix a heavy oil feedstock 202 that is contained in pressure vessel 210, a heavy oil source 220, a hydrogen gas source 222, and a catalyst 224 configured for upgrading heavy oil feedstock 202. Catalyst 224 may be least one of a fixed bed catalyst, a stirred bed catalyst, an ebullated bed catalyst, or a slurry phase catalyst. Catalyst(s) 224 may be configured for promoting upgrading reactions that crack, hydrogenate, remove sulfur, nitrogen, oxygen, and metals in heavy oil feedstock 202. Pressure vessel 210 also includes a heater 218 that may be used to maintain heavy oil 202 at a temperature sufficient for hydrocracking. The illustrated ultrasonicator includes an ultrasonic generator 222 that is connected to an ultrasonic transducer 220, which is in turn connected to an ultrasonic transmitter 216 that is positioned in pressure vessel 210 in contact with heavy oil 202. So positioned, ultrasonic transducer 220 and ultrasonic transmitter 216 are capable of transmitting ultrasonic energy into heavy oil 202.

Referring now to FIG. 3, another embodiment of an ultrasound cavitation reactor 300 is illustrated. Ultrasound cavitation reactor 300 includes a pressure vessel 310 that includes a heavy oil feedstock 302, a heater 318 that may be used to maintain the heavy oil 302 at a temperature sufficient for hydrocracking, a heavy oil source 330, a hydrogen gas source 332, and a catalyst 334 configured for upgrading the heavy oil feedstock 302. Catalyst 334 may be least one of a fixed bed catalyst, a stirred bed catalyst, an ebullated bed catalyst, or a slurry phase catalyst. Catalyst(s) 334 may be configured for promoting upgrading reactions that crack, hydrogenate, remove sulfur, nitrogen, oxygen, and metals in heavy oil feedstock 302. Ultrasound cavitation reactor 300 further includes a circulating channel 312 fluidly coupled to pressure vessel 310 and a pump 314 that is configured to pump heavy oil 302 through a flow channel 312. Flow channel 312 also optionally includes a heater 318a that may be used to maintain the temperature of the heavy oil at a hydrocracking temperature.

The ultrasonicator system of ultrasound cavitation reactor 300 includes an ultrasonic generator 326 that is connected to an ultrasonic transducer 324, which is in turn connected to an ultrasonic transmitter 322. Ultrasonic transmitter 322 is positioned in fluid contact with heavy oil 302 in a flow cell 320 that is positioned in flow channel 312. Pump 314 circulates heavy oil 302 through flow channel 312, through flow cell 320 where heavy oil 302 is sonicated, and back into pressure vessel 310.

As explained in greater detail above, the ultrasonic or other cavitation energy creates shockwaves, cavitation, etc. that create extremely high localized pressures and temperatures that can create hydrocracking conditions at lower bulk temperature and hydrogen pressures than can typically be used for hydrotreatment. Likewise, the action of the ultrasonicator can break up catalyst aggregates, in the case of a slurry or oil miscible catalyst, and create more intimate contact between the oil, the catalyst, and the hydrogen gas, which can improve or enhance reaction rates. And while each of FIGS. 2 and 3 illustrate one ultrasonicator, one will appreciate that the ultrasound cavitation reactors described herein may include multiple ultrasonicators, which may be operated with different pulse sequences and at different power and frequency settings depending on the volume of oil being upgraded, throughput, and other design parameters. Ultrasonicators devices that can be incorporated into the ultrasound reactors described herein are commercially available from a number of vendors. One vendor of ultrasonicators is Hielscher Ultrasonics GmbH of Teltow, Germany.

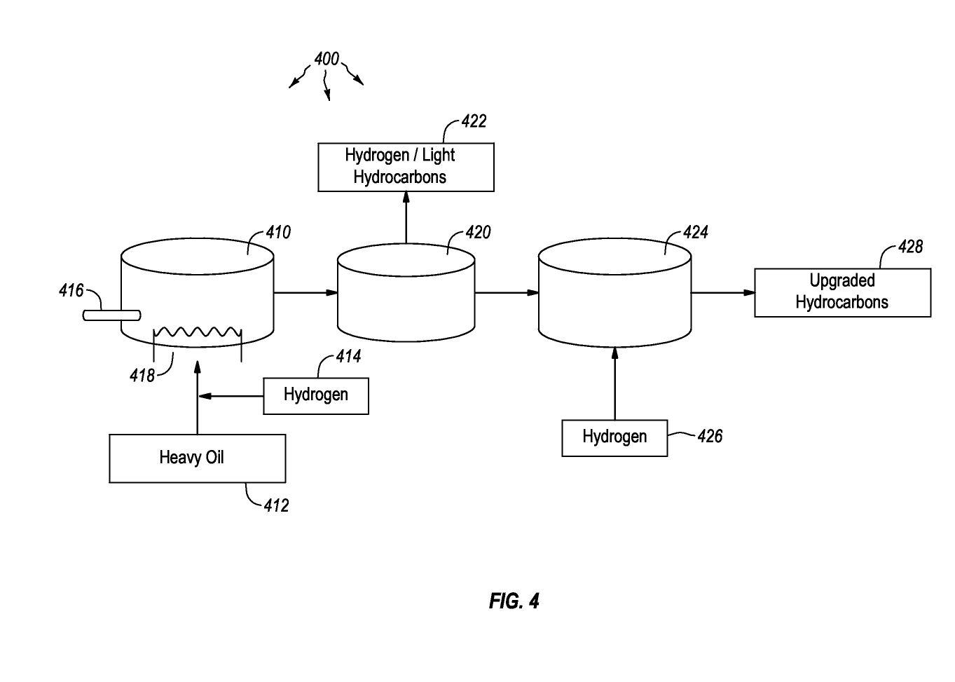

Referring now to FIG. 4, another process flow diagram 400 is illustrated. A heavy oil feedstock 412 is first upgraded in an ultrasound cavitation reactor 410 in the presence of hydrogen feed gas 414 and a catalyst. As with the embodiment described relative to FIG. 1, ultrasound cavitation reactor 410 includes an ultrasonicator 416 and a heater 418. Upgraded heavy oil is fed to a flash separator 420, which removes excess hydrogen and light product 422 from an upgraded heavy oil product. The upgraded heavy oil from flash separator 420 is then pumped into a higher pressure backmixed bubbling reactor 424 along with fresh hydrogen 426. The backmixed bubbling reactor bubbles hydrogen through the heavy oil at elevated temperature (e.g., 380° C. to 460° C.) in the presence of a catalyst at a hydrogen pressure range of from about 500 to 4000 psig depending on the desired level of hydrocarbons conversion and feedstock properties.

Upgraded product 428 from the backmixed bubbling reactor 424 may be processed in conventional scheme using atmospheric and vacuum distillation according to processing techniques known in the art. Unconverted hydrocarbons may be recycled back to the one of ultrasound reactor 410 or backmixed bubbling reactor 424 for further upgrading. Unconverted hydrocarbons may be subjected to solvent extraction to recover the insoluble hydrocarbons and catalyst. The insoluble fraction (i.e., non-upgraded hydrocarbons) may be further processed in ultrasound reactor 410 or in backmixed bubbling reactor 424. Likewise, upgraded product 428 from backmixed bubbling reactor 424 may be further hydrocracked in one or more additional backmixed bubbling reactors connected in series.

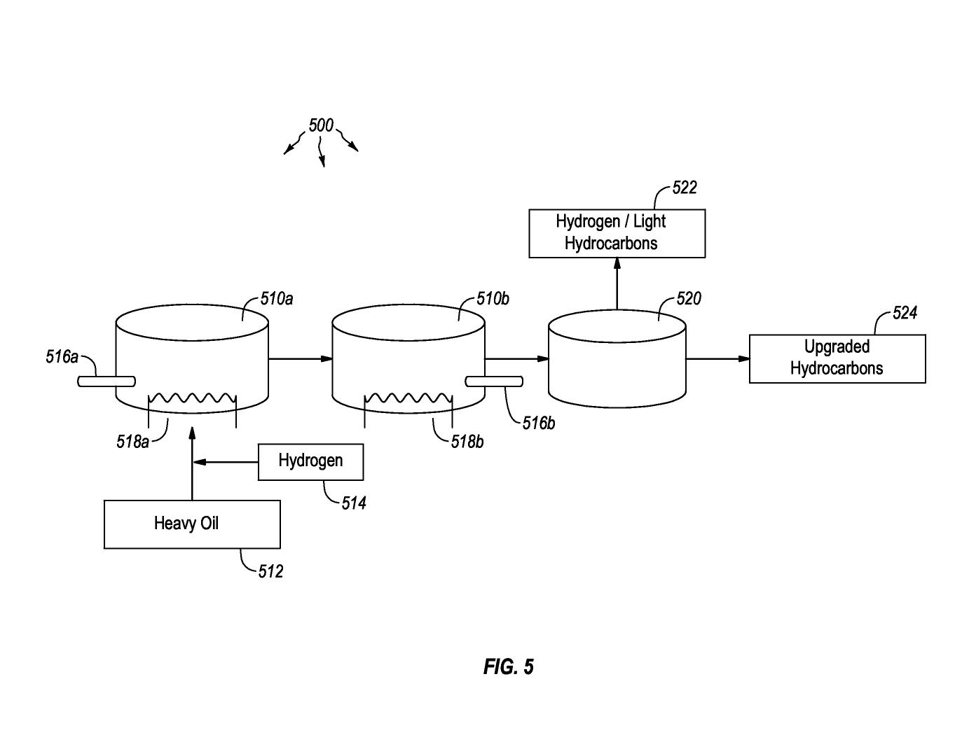

Referring now to FIG. 5, another process flow scheme 500 is illustrated for upgrading hydrocarbons. Flow scheme 500 includes a first ultrasound cavitation reactor 510a and a second ultrasound cavitation reactor 510b connected in series. First ultrasound cavitation reactor 510a includes an ultrasonicator 516a and a heater 518a; second ultrasound cavitation reactor 510b also includes an ultrasonicator 516b and a heater 518b. While FIG. 5 illustrates two ultrasound cavitation reactors 510a and 510b, one will appreciate that a heavy oil upgrading system may include multiple ultrasound cavitation reactors in series.

A heavy oil feedstock 512 is upgraded in in first ultrasound cavitation reactor 510a in the presence of hydrogen feed gas 514 and a catalyst. After treatment in first ultrasound cavitation reactor 510a, upgraded heavy oils are fed to second ultrasound cavitation reactor 510b for additional treatment. In second ultrasound cavitation reactor 510b, fresh hydrogen and catalyst may be added or second ultrasound cavitation reactor 510b may use hydrogen and catalyst from first ultrasound cavitation reactor 510a. After treatment in second ultrasound cavitation reactor 510b, upgraded heavy oil is fed to a flash separator 520, which removes excess hydrogen and light product 522 to yield an upgraded heavy oil product 524.

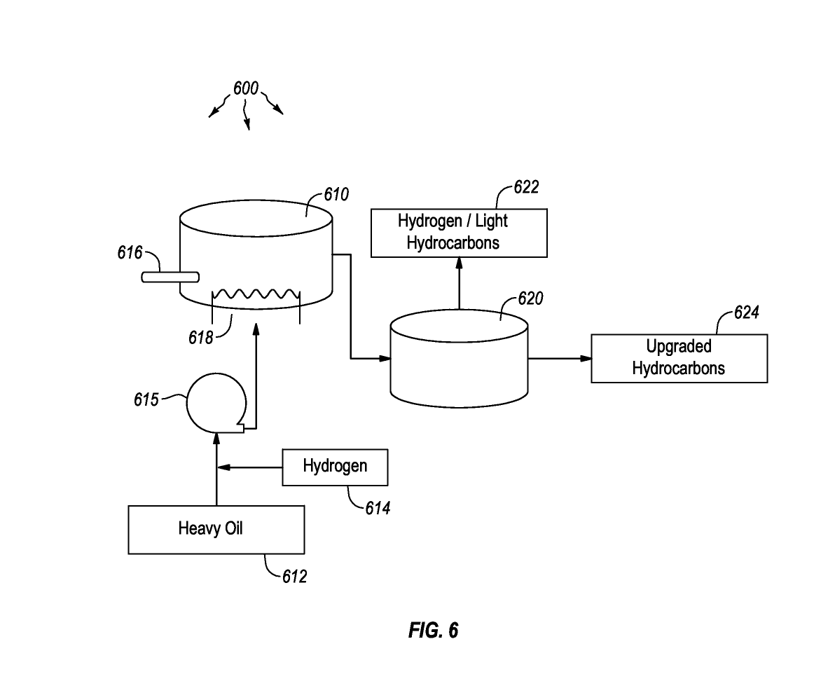

Referring now to FIG. 6, another process flow scheme 600 for upgrading heavy oil is illustrated. Flow scheme 600 includes an ultrasound cavitation reactor 610, which includes an ultrasonicator 616 and a heater 618. Heavy oil 612 and hydrogen 614 are fed into ultrasound cavitation reactor 610 by first passing through a pump 615. The heavy oil may be processed in ultrasonic cavitation reactor 610 and fed to a flash separator 620 for separation of unreacted hydrogen and light hydrocarbons 622 from an upgraded hydrocarbon fraction 624, as described above.

In one embodiment, pump 615 may be configured to admix hydrogen 614 into heavy oil 612 prior to introducing heavy oil 612 into cavitation reactor 610. Likewise, pump 615 may also be used to admix a slurry catalyst or the like into heavy oil 612 prior to introducing the mix into cavitation reactor 610. In one embodiment, pump 615 may be a cavitation pump. A cavitation pump is a special type of pump that can be used can be used to mimic some of the cavitation effects an ultrasonicator (e.g., cavitation of micobubbles) that can heat or mix the heavy oil/catalyst and hydrogen and enhance reaction rates. Likewise, a cavitation pump can be used to generate microbubbles of hydrogen in the heavy oil that can then be acted upon by ultrasonicator 616 when heavy oil is introduced into ultrasonic cavitation reactor 610. One vendor of cavitation pumps is Hydro Dynamics, Inc. of Rome, Ga. A cavitation pump can be included in any of the process flow diagrams illustrated herein.

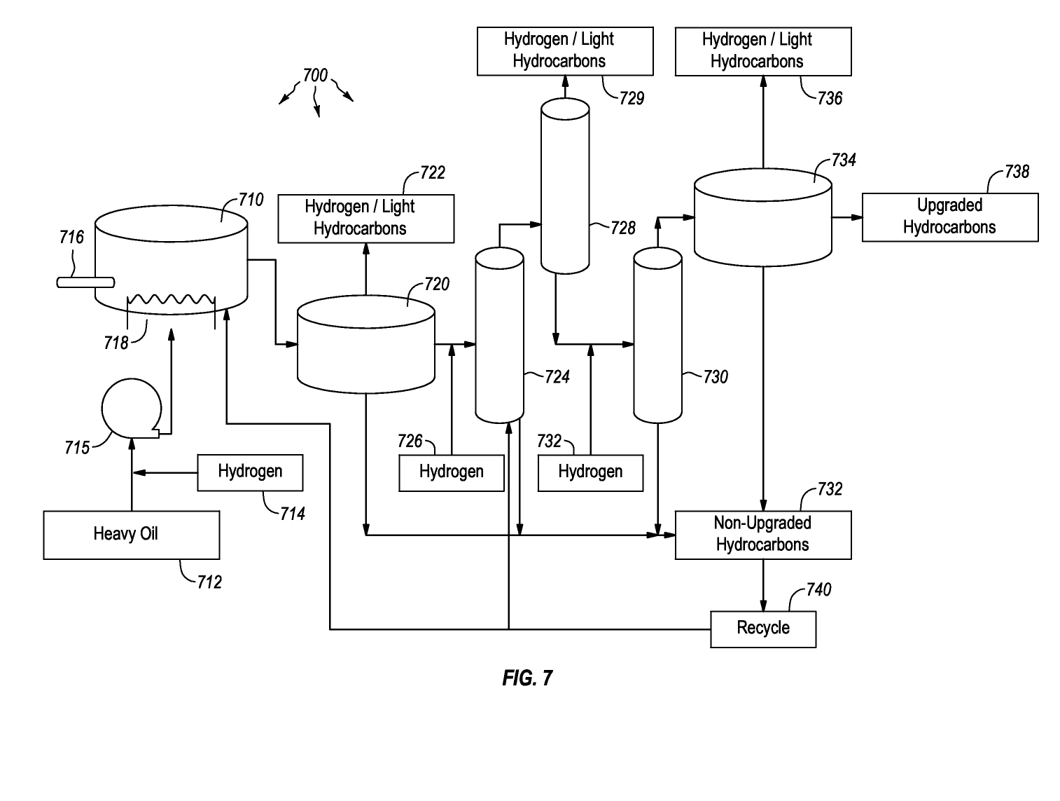

Referring now to FIG. 7, another process flow scheme 700 is illustrated. Process flow scheme 700 includes a cavitation pump 715 upstream of an ultrasound cavitation reactor 710 that can be used to disperse hydrogen 714 and/or catalyst in heavy oil 712 prior to feeding the heavy oil mix into ultrasound cavitation reactor 710. Process flow scheme 700 also illustrates an embodiment of a downstream processing scheme for treating partially upgraded hydrocarbon with fresh hydrogen in at least two backmixed bubbling reactors in combination with an interstage separator, and recycling of unconverted hydrocarbons.

Following treatment in ultrasound cavitation reactor 710, upgraded heavy oil is fed to a flash separator 720 for separation of unreacted hydrogen and light hydrocarbons 722 from an upgraded hydrocarbon fraction, as described above. The upgraded hydrocarbon fraction may be fed with fresh hydrogen 726 into a first backmixed bubbling reactor 724 and further upgraded as described above. Further upgraded hydrocarbons from first backmixed bubbling reactor 724 may be fed to an interstage separator 728 for separation of unreacted hydrogen, light hydrocarbons, and upgraded hydrocarbon product 729 from the heavy oil fraction. The upgraded hydrocarbon fraction from interstage separator 728 may then be fed with fresh hydrogen 732 to a second backmixed bubbling reactor 730. Interstage separator 728 between first and second backmixed bubbling reactors 724 and 730 increases reactor performance by removing converted product and adding fresh hydrogen increases hydrogen partial pressure leading to higher reaction rate.

Following treatment in second backmixed bubbling reactor 730, upgraded hydrocarbons may be fed to a flash separator 734 for separation of unreacted hydrogen and light hydrocarbons 736 from upgraded hydrocarbon fraction 738. Upgraded product 738 from flash separator 734 may be processed in a conventional scheme using atmospheric and vacuum distillation according to processing techniques known in the art.

Non-converted hydrocarbons 732 from first flash separator 720, second flash separator 734, or second backmixed bubbling reactor 730 may be recycled 740 back to the one of ultrasound cavitation reactor 710 or first backmixed bubbling reactor 724 for further upgrading. Recycling of unconverted hydrocarbons further increases the concentration of catalyst in second backmixed bubbling reactor 730 as well as selectively increasing the reaction time of the unconverted hydrocarbons. Unconverted hydrocarbons may be subjected to solvent extraction to recover the insoluble hydrocarbons and catalyst. An insoluble fraction (i.e., non-upgraded hydrocarbons) may be further processed in ultrasound cavitation reactor 710 or in backmixed bubbling reactor 724.

### III. Methods for Upgrading a Heavy Oil Feedstock

In an embodiment, a method for upgrading a heavy oil feedstock is disclosed. The method includes (1) providing a heavy oil feedstock, hydrogen gas, and a catalyst configured for upgrading the heavy oil feedstock, (2) providing an ultrasonic cavitation reactor that includes a pressure vessel, a heater configured to heat the heavy oil feedstock to a temperature sufficient for hydrocracking, and an ultrasonicator positioned so as to contact the heavy oil feedstock, and (3) combining the hydrogen gas, the heavy oil feedstock, and the catalyst in the ultrasonic cavitation reactor under hydrocracking conditions to convert at least a portion of the heavy oil feedstock to lower boiling hydrocarbons, wherein the hydrogen gas is at less than 500 psig. The heater, often a gas fired heater, may typically be positioned outside of the pressure vessel; however, in some embodiments, the heater or an additional heater may be positioned in the pressure vessel. The method further includes (4) transmitting ultrasonic energy into the heavy oil feedstock in contact with the heavy oil feedstock, the hydrogen gas, and the catalyst so as to form volatile upgraded products and non-volatile upgraded products from the heavy oil feedstock, and (5) recovering the volatile and non-volatile upgraded products from an upgraded heavy oil feedstock.

In one embodiment of the method, the ultrasonicator includes an ultrasonic transmitter positioned in the pressure vessel in contact with the heavy oil feedstock and the pressure vessel further comprises a mixer for mixing the heavy oil feedstock in contact with the ultrasonic transmitter. In another embodiment, of the method, the ultrasonicator includes a circulating channel fluidly coupled to the pressure vessel, an ultrasonic transmitter positioned in a flow cell positioned along the circulating channel, and a pump fluidly coupled to the circulating channel configured to pump the heavy oil feedstock from the pressure vessel, through the circulating channel and the flow cell, and back into the pressure vessel.

In one embodiment of the method, the recovering includes transferring the upgraded heavy oil feedstock to a flash separator downstream of the ultrasonic cavitation reactor, wherein the flash separator is configured for separating unreacted hydrogen and volatile upgraded products from the upgraded heavy oil feedstock.

In one embodiment, the method includes further upgrading the heavy oil. The further upgrading includes transferring the upgraded heavy oil feedstock from the flash separator to a first backmixed bubbling reactor, the first backmixed bubbling reactor comprising the upgraded hydrocarbons separated by the flash separator, a gaseous phase comprised of fresh hydrogen gas, a sparger for bubbling the gaseous phase through the upgraded heavy oil feedstock, transferring the upgraded heavy oil feedstock from the first backmixed bubbling reactor to an interstage separator, the interstage separator being configured for separating unreacted hydrogen and volatile hydrocarbons from the upgraded heavy oil feedstock generated in the first backmixed bubbling reactor, and transferring the upgraded heavy oil feedstock from the interstage separator to a second backmixed bubbling reactor. The further upgrading may further include recycling unconverted heavy oil feedstock back to the ultrasonic cavitation reactor from one or more of the flash separator, the first backmixed bubbling reactor, the interstage separator, or the second backmixed bubbling reactor.

In one embodiment, the method may further include providing a cavitation pump upstream of the ultrasonic cavitation reactor, and intimately mixing the heavy oil feedstock and hydrogen gas using the cavitation pump so as to create hydrogen microbubbles in the heavy oil feedstock prior to introducing the heavy oil feedstock into the ultrasonic cavitation reactor.

In one embodiment, the method further includes providing a second ultrasonic cavitation reactor downstream of a first ultrasonic cavitation reactor, transferring an upgraded heavy oil feedstock from the first ultrasonic cavitation reactor to the second ultrasonic cavitation reactor, combining fresh hydrogen gas with the upgraded heavy oil feedstock under hydrocracking conditions, wherein the fresh hydrogen gas is at less than 500 psig, and transmitting ultrasonic energy into the upgraded heavy oil feedstock so as to further upgrade the upgraded heavy oil feedstock.

In another embodiment, a method for upgrading a heavy oil feedstock is disclosed. The method includes (1) providing a heavy oil feedstock, hydrogen gas, and a catalyst configured for upgrading the heavy oil feedstock, wherein the catalyst is at least one of a fixed bed catalyst, a stirred bed catalyst, an ebullated bed catalyst, a slurry phase catalyst, or molecular sized catalyst generated within the heavy oil feedstock via activation of the hydrocarbon soluble catalyst precursor, (2) providing a first ultrasonic cavitation reactor that includes a pressure vessel, a heater configured to heat the heavy oil feedstock to a temperature sufficient for hydrocracking, and an ultrasonicator positioned in contact with the heavy oil feedstock, (3) combining the hydrogen gas, the heavy oil feedstock, and the catalyst the ultrasonic cavitation reactor under hydrocracking conditions to convert at least a portion of the heavy oil feedstock to lower boiling hydrocarbons, wherein the hydrogen gas is at less than 500 psig, and (4) transmitting ultrasonic energy into the heavy oil feedstock in contact with the heavy oil feedstock, the hydrogen gas, and the catalyst so as to form an upgraded heavy oil feedstock that includes volatile upgraded products and non-volatile upgraded products.

The method further includes a step (5) of transferring the upgraded heavy oil feedstock from the first ultrasonic cavitation reactor to a flash separator, the flash separator being configured for separating unreacted hydrogen and the volatile upgraded products from the upgraded heavy oil feedstock, and a step (6) of transferring the upgraded heavy oil feedstock from the flash separator to a first backmixed bubbling reactor. The method further includes a step (7) of transferring the upgraded heavy oil feedstock from the first backmixed bubbling reactor to an interstage separator configured for separating unreacted hydrogen and volatile hydrocarbons from the upgraded heavy oil feedstock from the first backmixed bubbling reactor, a step (8) of transferring the upgraded heavy oil feedstock from the interstage separator to a second backmixed bubbling reactor, and a step (9) of recovering non-volatile upgraded products from the upgraded heavy oil feedstock from one or more of the first ultrasonic reactor, the flash separator, the first backmixed bubbling reactor, the interstage separator, or the second backmixed bubbling reactor.

In one embodiment, the method may include providing at least a second ultrasonic cavitation reactor downstream of the first ultrasonic cavitation reactor. In one embodiment, the method may further include mixing at least one of the hydrogen gas or a slurry phase catalyst into the heavy oil feedstock with a mixing apparatus prior to introducing the heavy oil feedstock the first ultrasonic cavitation reactor. In one embodiment, the mixing apparatus includes a cavitation pump, the cavitation pump being configured to intimately mix at least the heavy oil feedstock and hydrogen gas to create hydrogen microbubbles therein.

In one embodiment, the method further includes recycling the residuum portion of the partially converted feedstock from one or more of the flash separator, the first backmixed bubbling reactor, the interstage separator, or the second backmixed bubbling reactor back to the first ultrasonic cavitation reactor.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A heavy oil upgrading system, comprising:
an ultrasonic cavitation reactor that includes:
a heavy oil feedstock;
a pressure vessel including a heater configured for heating the heavy oil feedstock in the pressure vessel to a temperature sufficient for hydrocracking;
hydrogen gas at less than 500 psig dispersed in the heavy oil feedstock;
a catalyst configured for promoting upgrading reactions that crack, hydrogenate, remove sulfur, nitrogen, oxygen, and metals in the heavy oil feedstock;
an ultrasonicator positioned and configured to transmit ultrasonic energy in contact with the heavy oil feedstock, the hydrogen gas, and the catalyst.

2. The heavy oil upgrading system of claim 1, wherein the ultrasonicator includes an ultrasonic transmitter positioned in the pressure vessel in contact with the heavy oil feedstock and the pressure vessel further comprises a mixer for mixing the heavy oil feedstock in contact with the ultrasonic transmitter.

3. The heavy oil upgrading system of claim 1, wherein the ultrasonicator includes a circulating channel fluidly coupled to the pressure vessel, an ultrasonic transmitter positioned in a flow cell positioned along the circulating channel, and a pump fluidly coupled to the circulating channel configured to pump the heavy oil feedstock from the pressure vessel, through the circulating channel and the flow cell, and back into the pressure vessel.

4. The heavy oil upgrading system of claim 1, wherein the ultrasonicator operates at a frequency of 10 kHz to 200 kHz and a power of 100 W to 2000 W.

5. The heavy oil upgrading system of claim 1, wherein the catalyst is at least one of a fixed bed catalyst, a stirred bed catalyst, an ebullated bed catalyst, or a slurry phase catalyst.

6. The heavy oil upgrading system of claim 5, wherein the slurry phase catalyst is one or more of a pulverized heterogeneous catalyst, an oil soluble catalyst, or an oil soluble catalyst precursor compound.

7. The heavy oil upgrading system of claim 1, wherein the ultrasonic energy includes one or more of cavitation forces, shear, microjets, shockwaves, micro-convection, or local hotspots.

8. The heavy oil upgrading system of claim 1, further comprising a flash separator downstream of the ultrasonic cavitation reactor, wherein the flash separator is configured for separating unreacted hydrogen and volatile hydrocarbons having a boiling point up to 400° C. from upgraded hydrocarbons generated in the ultrasonic cavitation reactor.

9. The heavy oil upgrading system of claim 8, further comprising at least one fixed bed reactor downstream of the flash separator, wherein the fixed bed reactor includes a supported catalyst configured for removing sulfur from the heavy oil feedstock.

10. The heavy oil upgrading system of claim 8, further comprising at least one backmixed bubbling reactor downstream of the flash separator, wherein the at least one backmixed bubbling reactor comprises a liquid phase containing the upgraded hydrocarbons separated by the flash separator, a gaseous phase comprised of hydrogen gas, a sparger for bubbling the gaseous phase through the liquid phase, and a recirculating system, and wherein the at least one backmixed bubbling reactor operates at a temperature in a range of 380° C. to 460° C. and a hydrogen partial pressure of up to 4000 psig.

11. The heavy oil upgrading system of claim 10, wherein the least one backmixed bubbling reactor comprises at least one of a fixed bed catalyst, a stirred bed catalyst, an ebullated bed catalyst, or a slurry phase catalyst.

12. The heavy oil upgrading system of claim 10, wherein the at least one backmixed bubbling reactor comprises a supported catalyst configured for removing sulfur from the heavy oil feedstock.

13. The heavy oil upgrading system of claim 1, further comprising a mixing apparatus positioned upstream of the ultrasonic cavitation reactor for intimately mixing at least one of a slurry phase catalyst or the hydrogen gas with the heavy oil feedstock prior to introducing the heavy oil feedstock into the ultrasonic cavitation reactor.

14. The heavy oil upgrading system of claim 13, wherein the mixing apparatus is a cavitation pump, wherein the cavitation pump is configured to intimately mix the heavy oil feedstock and hydrogen gas to create hydrogen microbubbles therein.

15. The heavy oil upgrading system of claim 1, further comprising a second ultrasonic cavitation reactor downstream of the ultrasonic cavitation reactor of claim 1, and optionally a flash separator downstream of the at least a second ultrasonic cavitation reactor.

16. The heavy oil upgrading system of claim 1, further comprising:
a cavitation pump upstream of the ultrasonic cavitation reactor, the cavitation pump being configured to intimately mix at least the heavy oil feedstock and hydrogen gas to create hydrogen microbubbles therein;
a flash separator downstream of the ultrasonic cavitation reactor, the flash separator being configured for separating unreacted hydrogen and volatile hydrocarbons from upgraded hydrocarbons generated in the ultrasonic cavitation reactor;
a first backmixed bubbling reactor downstream of the flash separator, the first backmixed bubbling reactor comprising the upgraded hydrocarbons separated by the flash separator, a gaseous phase comprised of fresh hydrogen gas, a sparger for bubbling the gaseous phase through the upgraded hydrocarbons;
an interstage separator downstream of the first backmixed bubbling reactor, the interstage separator being configured for separating unreacted hydrogen and volatile hydrocarbons from upgraded hydrocarbons generated in the first backmixed bubbling reactor;
a second backmixed bubbling reactor downstream of the interstage separator, the second backmixed bubbling reactor comprising the upgraded hydrocarbons separated by the interstage separator, a gaseous phase comprised of fresh hydrogen gas, a sparger for bubbling the gaseous phase through the upgraded hydrocarbons; and
a recycling system for recycling unconverted heavy oil from one or more of the flash separator, the first backmixed bubbling reactor, the interstage separator, or the second backmixed bubbling reactor.

17. The heavy oil upgrading system of claim 16, wherein the recycling system returns unconverted heavy oil to the ultrasonic cavitation reactor.

18. A method for upgrading a heavy oil feedstock, comprising:
providing a heavy oil feedstock, hydrogen gas, and a catalyst configured for upgrading the heavy oil feedstock;
providing a cavitation reactor that includes a pressure vessel, a heater configured for heating the heavy oil feedstock in the pressure vessel to a temperature sufficient for hydrocracking, and a cavitation generator positioned so as to contact the heavy oil feedstock;
combining the hydrogen gas, the heavy oil feedstock, and the catalyst the ultrasonic reactor under hydrocracking conditions to convert at least a portion of the heavy oil feedstock to lower boiling hydrocarbons, wherein the hydrogen gas is at less than 500 psig;
transmitting cavitation energy into the heavy oil feedstock in contact with the heavy oil feedstock, the hydrogen gas, and the catalyst so as to form volatile upgraded products and non-volatile upgraded products from the heavy oil feedstock; and
recovering the volatile and non-volatile upgraded products from an upgraded heavy oil feedstock.

19. The method of claim 18, wherein the cavitation generator includes an ultrasonic transmitter positioned in the pressure vessel in contact with the heavy oil feedstock and the pressure vessel further comprises a mixer for mixing the heavy oil feedstock in contact with the ultrasonic transmitter.

20. The method of claim 18, wherein the cavitation generator includes a circulating channel fluidly coupled to the pressure vessel, an ultrasonic transmitter positioned in a flow cell positioned along the circulating channel, and a pump fluidly coupled to the circulating channel configured to pump the heavy oil feedstock from the pressure vessel, through the circulating channel and the flow cell, and back into the pressure vessel.

21. The method of claim 18, wherein the catalyst comprises at least one of a fixed bed catalyst, a stirred bed catalyst, an ebullated bed catalyst, or a slurry phase catalyst.

22. The method of claim 18, wherein the recovering includes transferring the upgraded heavy oil feedstock to a flash separator downstream of the cavitation reactor, wherein the flash separator is configured for separating unreacted hydrogen and volatile upgraded products from the upgraded heavy oil feedstock.

23. The method of claim 22, further upgrading the upgraded heavy oil feedstock from the flash separator, the further upgrading comprising:
transferring the upgraded heavy oil feedstock from the flash separator to a first backmixed bubbling reactor, the first backmixed bubbling reactor comprising the upgraded hydrocarbons separated by the flash separator, a gaseous phase comprised of fresh hydrogen gas, a sparger for bubbling the gaseous phase through the upgraded heavy oil feedstock; and
transferring the upgraded heavy oil feedstock from the first backmixed bubbling reactor to an interstage separator, the interstage separator being configured for separating unreacted hydrogen and volatile hydrocarbons from the upgraded heavy oil feedstock generated in the first backmixed bubbling reactor.

24. The method of claim 22, further comprising:
transferring the upgraded heavy oil feedstock from the interstage separator to a second backmixed bubbling reactor, the second backmixed bubbling reactor comprising the upgraded hydrocarbons separated by the interstage separator, a gaseous phase comprised of fresh hydrogen gas, a sparger for bubbling the gaseous phase through the upgraded hydrocarbons; and
recycling unconverted heavy oil feedstock back to the ultrasonic reactor from one or more of the flash separator, the first backmixed bubbling reactor, the interstage separator, or the second backmixed bubbling reactor.

25. The method of claim 18, further comprising:
providing a cavitation pump upstream of the cavitation reactor;
intimately mixing the heavy oil feedstock and hydrogen gas using the cavitation pump so as to create hydrogen microbubbles in the heavy oil feedstock prior to introducing the heavy oil feedstock into the cavitation reactor.

26. The method of claim 18, further comprising:
providing a second cavitation reactor downstream of the cavitation reactor;
transferring an upgraded heavy oil feedstock from the cavitation reactor to the second cavitation reactor;
combining fresh hydrogen gas with the upgraded heavy oil feedstock under hydrocracking conditions, wherein the fresh hydrogen gas is at less than 500 psig; and
transmitting cavitation energy into the upgraded heavy oil feedstock so as to further upgrade the upgraded heavy oil feedstock.

27. A method for upgrading a heavy oil feedstock, comprising:
providing a heavy oil feedstock, hydrogen gas, and a catalyst configured for upgrading the heavy oil feedstock, wherein the catalyst is at least one of a fixed bed catalyst, a stirred bed catalyst, an ebullated bed catalyst, or a slurry phase catalyst;
providing an ultrasonic cavitation reactor that includes a pressure vessel, a heater configured for heating the heavy oil feedstock in the pressure vessel to a temperature sufficient for hydrocracking, and an ultrasonicator positioned in contact with the heavy oil feedstock;
combining the hydrogen gas, the heavy oil feedstock, and the catalyst in the ultrasonic cavitation reactor under hydrocracking conditions to convert at least a portion of the heavy oil feedstock to lower boiling hydrocarbons, wherein the hydrogen gas is at less than 500 psig;
transmitting ultrasonic energy into the heavy oil feedstock in contact with the heavy oil feedstock, the hydrogen gas, and the catalyst so as to form an upgraded heavy oil feedstock that includes volatile upgraded products and non-volatile upgraded products;
transferring the upgraded heavy oil feedstock from the ultrasonic cavitation reactor to a flash separator, the flash separator being configured for separating unreacted hydrogen and the volatile upgraded products from the upgraded heavy oil feedstock;
transferring the upgraded heavy oil feedstock from the flash separator to a first backmixed bubbling reactor, the first backmixed bubbling reactor comprising the upgraded heavy oil feedstock from the flash separator, a gaseous phase comprised of fresh hydrogen gas, a sparger for bubbling the gaseous phase through the upgraded hydrocarbons;
transferring the upgraded heavy oil feedstock from the first backmixed bubbling reactor to an interstage separator, the interstage separator being configured for separating unreacted hydrogen and volatile hydrocarbons from the upgraded heavy oil feedstock from the first backmixed bubbling reactor;
transferring the upgraded heavy oil feedstock from the interstage separator to a second backmixed bubbling reactor, the second backmixed bubbling reactor comprising the upgraded heavy oil feedstock from the interstage separator, a gaseous phase comprised of fresh hydrogen gas, a sparger for bubbling the gaseous phase through the upgraded hydrocarbons; and
recovering non-volatile upgraded products from the upgraded heavy oil feedstock from one or more of the ultrasonic cavitation reactor, the flash separator, the first backmixed bubbling reactor, the interstage separator, or the second backmixed bubbling reactor.
